(19) United States
(12) Patent Application Publication
(10) Pub. No.: US 2024/0214897 A1
(43) Pub. Date: Jun. 27, 2024

(54) METHOD AND DEVICE FOR HANDOVER IN AN EFB-BASED NON-TERRESTRIAL NETWORK

(71) Applicants: HYUNDAI MOTOR COMPANY, Seoul (KR); KIA CORPORATION, Seoul (KR); INHA UNIVERSITY RESEARCH AND BUSINESS FOUNDATION, Incheon (KR)

(72) Inventors: Young Kil Suh, Hwaseong-si (KR); Gene Back Hahn, Hwaseong-si (KR); Ui Hyun Hong, Hwaseong-si (KR); Duk Kyung Kim, Seoul (KR)

(73) Assignees: HYUNDAI MOTOR COMPANY, Seoul (KR); KIA CORPORATION, Seoul (KR); INHA UNIVERSITY RESEARCH AND BUSINESS FOUNDATION, Incheon (KR)

(21) Appl. No.: 18/405,492

(22) Filed: Jan. 5, 2024

Related U.S. Application Data
(63) Continuation of application No. PCT/KR2022/009779, filed on Jul. 6, 2022.

(30) Foreign Application Priority Data
Jul. 7, 2021 (KR) 10-2021-0089291

(51) Int. Cl. H04W 36/24; H04W 76/19; H04W 84/06

(52) U.S. Cl. CPC H04W 36/249; H04W 76/19; H04W 84/06

(57) ABSTRACT

A method and a device for handover in an EFB-based non-terrestrial network are provided. The method may be performed in a first cell of a first satellite. The method includes performing a connection configuration procedure with a UE. The method also includes, after performing the connection configuration procedure, decreasing a value of a cell service timer, that indicates the time at which a communication service can be provided in the first cell, according to a decrement interval. The method additionally includes, in response to determining that the cell service timer is below a threshold, triggering a handover procedure.

### CROSS-REFERENCE TO RELATED APPLICATION

This application is a Continuation of International Application No. PCT/KR2022/009779 filed on Jul. 6, 2022, which claims priority to Korean Patent Application No. 10-2021-0089291 filed on Jul. 7, 2021, the entire disclosures of which are incorporated herein by reference.

### TECHNICAL FIELD

The present disclosure relates generally to a handover technique for a non-terrestrial network. More particularly, the present disclosure relates to a handover technique for an earth fixed beam (EFB)-based non-terrestrial network.

### BACKGROUND

In order to provide enhanced communication services, a communication system (e.g., 5G communication network, 6G communication network, etc.) using a higher frequency band (e.g., a frequency band of 6 gigahertz (GHz) or above) than a frequency band (e.g., a frequency band of 6 GHz or below) of the long term evolution (LTE) communication system (or LTE-A communication system) is being considered. The 5G communication network (e.g., new radio (NR) communication network) may support not only a frequency band of 6 GHz or below, but also a frequency band of 6 GHz or above. The 5G communication network (e.g., new radio (NR) communication network) may further support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and/or the like. In addition, in order to provide enhanced communication services compared to the 5G communication network, the 6G communication network may support various and wide frequency bands and may be applied to various usage scenarios (e.g., terrestrial communication, non-terrestrial communication, sidelink communication, and/or the like).

The communication network (e.g., 5G communication network, 6G communication network, etc.) may provide communication services to terminals located on the ground. Recently, the demand for communication services for not only terrestrial but also non-terrestrial airplanes, drones, and satellites has been increasing. For this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g., airplane, drone, or the like) may be performed based on 5G communication technology, 6G communication technology, and/or the like. In the NTN, the satellite may perform functions of a base station in a communication network (e.g., 5G communication network, 6G communication network, and/or the like).

In a terrestrial network (TN), a handover procedure may be performed based on reference signal received powers (RSRPs). Although communication services are provided over a wide coverage due to a high altitude of the satellite in the NTN, a difference in RSRP within the coverage may be relatively small. Due to the randomness characteristics of the channel in the NTN, the RSRP-based handover procedure may not be performed as effectively as the handover procedure in the TN. In addition, in the NTN, a cell coverage may be difficult to precisely configured based on reception quality (e.g., RSRP, reference signal received quality (RSRQ)) alone.

### SUMMARY

It is expected that the effectiveness of a conditional handover (CHO) procedure will increase due to a long delay time of the channel in the NTN, but since the CHO procedure is performed based on RSRP, improvement of the CHO procedure may be required.

The present disclosure is directed to providing a method and an apparatus for handover in a non-terrestrial network.

According to an embodiment of the present disclosure, a method is provided that may be performed in a first cell of a first satellite. The method may include performing a connection establishment procedure with a user equipment (UE). The method may also include, after performing the connection establishment procedure, decreasing a value of a cell service timer, that indicates a time during which a communication service can be provided in the first cell, according to a decrement interval. The method may additionally include, in response to determining that the cell service timer is below a threshold, triggering a handover procedure.

Performing the connection establishment procedure may include transmitting first information indicating a handover scheme to the UE. The first information may indicate a satellite triggering scheme among the satellite triggering scheme or a UE triggering scheme. When the satellite triggering scheme is used, the handover procedure may be triggered by a satellite. When the UE triggering scheme is used, the handover procedure may be triggered by the UE.

The method may further include, in response to determining that the cell service timer is below the threshold, transmitting second information, that indicates performing a frequent measurement procedure instead of an intermittent measurement procedure, to the UE when configuration information of the intermittent measurement procedure and configuration information of the frequent measurement procedure are signaled to the UE in the connection establishment procedure.

Triggering the handover procedure may include determining a target cell for the UE as a second cell and transmitting a handover request message to the second cell.

The target cell may be determined based on reception quality information received from the UE.

The first cell may be configured by the first satellite based on earth fixed beam (EFB). The second cell may be configured by the first satellite or a second satellite.

The handover procedure triggered by the first cell may be performed on a UE basis or a cell basis.

According to another embodiment of the present disclosure, a method is provided that may be performed in a user equipment (UE). The method may include receiving first handover configuration information from a first cell. The first handover configuration information may include information on a first cell service timer that indicates a time during which a communication service can be provided in the first cell of the first satellite. The method may also include decreasing the first cell service timer according to a decrement interval. The method may additionally include, in response to determining that the first cell service timer is below a threshold, transmitting a handover initiation message to the first cell.

The first handover configuration information may further include at least one of information indicating the decrement interval, information indicating the threshold, or information indicating a handover scheme.

The handover scheme may be classified into a satellite triggering scheme and a UE triggering scheme. The first handover configuration information may indicate the UE triggering scheme. A handover procedure may be triggered by the UE when the UE triggering scheme is used. The handover procedure may be triggered by the first satellite when the satellite triggering scheme is used.

The method may further include receiving, from the first cell, intermittent measurement configuration information and frequent measurement configuration information. An intermittent measurement procedure may be performed based on the intermittent measurement configuration information when the first cell service timer exceeds the threshold. A frequent measurement procedure may be performed based on the frequent measurement configuration information when the first cell service timer is equal to or below the threshold.

A measurement periodicity for the intermittent measurement procedure may be set longer than a measurement periodicity for the frequent measurement procedure. A measurement reporting periodicity for the intermittent measurement procedure may be set longer than a measurement reporting periodicity for the frequent measurement procedure.

The method may further include receiving a handover command message from the first cell. The method may additionally include performing a connection establishment procedure with a second cell based on the handover command message. Second handover configuration information, including information on a second cell service timer, that indicates a time during which communication services can be provided by the second cell, may be received from the second cell in the connection establishment procedure.

A handover procedure triggered by the handover initiation message may be performed on a UE basis or a cell basis. The first cell may be configured by the first satellite based on earth fixed beam (EFB). The second cell may be configured by the first satellite or a second satellite.

According to yet another embodiment of the present disclosure, a UE apparatus is provided. The UE apparatus may include a processor and a memory storing one or more instructions executable by the processor. The one or more instructions, when executed by the processor, may cause the processor to receive first handover configuration information from a first cell. The first handover configuration information may include information on a first cell service timer that indicates a time during which a communication service can be provided in the first cell of a first satellite. The one or more instructions, when executed by the processor, may also cause the processor to decrease a value of the first cell service timer according to a decrement interval. The one or more instructions, when executed by the processor, may additionally cause the processor to, in response to determining that the first cell service timer is below a threshold, cause a handover initiation message to be transmitted to the first cell.

The first handover configuration information may further include at least one of information indicating the decrement interval, information indicating the threshold, or information indicating a handover scheme.

The handover scheme may be classified into a satellite triggering scheme and a UE triggering scheme. The first handover configuration information may indicate the UE triggering scheme. A handover procedure may be triggered by the UE when the UE triggering scheme is used. The handover procedure may be triggered by the first satellite when the satellite triggering scheme is used.

The one or more instructions, when executed by the processor, may be further cause the processor to receive, from the first cell, intermittent measurement configuration information and frequent measurement configuration information. An intermittent measurement procedure may be performed based on the intermittent measurement configuration information when the first cell service timer exceeds the threshold. A frequent measurement procedure may be performed based on the frequent measurement configuration information when the first cell service timer is equal to or below the threshold.

The one or more instructions, when executed by the processor, may further cause the processor to receive a handover command message from the first cell and perform a connection establishment procedure with a second cell based on the handover command message. Second handover configuration information, including information on a second cell service timer, that indicates a time during which communication services can be provided by the second cell, may be received from the second cell in the connection establishment procedure.

A handover procedure triggered by the handover initiation message may be performed on a UE basis or a cell basis. The first cell may be configured by the first satellite based on earth fixed beam (EFB). The second cell may be configured by the first satellite or a second satellite.

According to embodiments of the present disclosure, a handover procedure in a non-terrestrial network can be triggered by a satellite (e.g., cell) or user equipment (UE) based on a cell service timer. When the handover procedure is triggered by the satellite and the cell service timer is equal to or below a threshold, the satellite may transmit a handover request message to another cell (or another satellite) to trigger the handover procedure. When the handover procedure is triggered by the UE and the cell service timer is equal to or below the threshold, the UE may transmit a handover initiation message to the satellite to trigger the handover procedure. Accordingly, the handover procedure can be performed efficiently in the non-terrestrial network and the performance of the non-terrestrial network can be improved.

### BRIEF DESCRIPTION OF THE DRAWINGS

FIG. 1A is a conceptual diagram illustrating a first embodiment of a non-terrestrial network.

FIG. 1B is a conceptual diagram illustrating a second embodiment of a non-terrestrial network.

FIG. 2A is a conceptual diagram illustrating a third embodiment of a non-terrestrial network.

FIG. 2B is a conceptual diagram illustrating a fourth embodiment of a non-terrestrial network.

FIG. 2C is a conceptual diagram illustrating a fifth embodiment of a non-terrestrial network.

FIG. 3 is a block diagram illustrating an embodiment of an entity constituting a non-terrestrial network.

FIG. 4A is a conceptual diagram illustrating an embodiment of a protocol stack of a user plane in a transparent payload-based non-terrestrial network.

FIG. 4B is a conceptual diagram illustrating an embodiment of a protocol stack of a control plane in a transparent payload-based non-terrestrial network.

FIG. 5A is a conceptual diagram illustrating an embodiment of a protocol stack of a user plane in a regenerative payload-based non-terrestrial network.

FIG. 5B is a conceptual diagram illustrating an embodiment of a protocol stack of a control plane in a regenerative payload-based non-terrestrial network.

FIG. 6A is a conceptual diagram illustrating a measurement result of reference signal received powers (RSRPs) in a terrestrial network, according to an embodiment.

FIG. 6B is a conceptual diagram illustrating a measurement result of RSRPs in a non-terrestrial network, according to an embodiment.

FIG. 7 illustrates an embodiment of a path according to a position of a UE within a beam coverage of a satellite.

FIG. 8A is a conceptual diagram illustrating a state of a satellite and a UE at a first time in an earth fixed beam (EFB)-based NTN, according to an embodiment.

FIG. 8B is a conceptual diagram illustrating a state of the satellite and the UE at a second time in the EFB-based NTN, according to an embodiment.

FIG. 8C is a conceptual diagram illustrating a state of the satellite and the UE at a third time in the EFB-based NTN, according to an embodiment.

FIG. 9 is a sequence chart illustrating an embodiment of a handover procedure based on a satellite triggering scheme in NTN.

FIG. 10 is a sequence chart illustrating an embodiment of a handover procedure based on a UE triggering scheme in NTN.

### DETAILED DESCRIPTION

While the present disclosure is capable of various modifications and alternative forms, specific embodiments thereof are shown by way of example in the drawings and are be described in detail below. It should be understood, however, that there is no intent to limit the present disclosure to the particular forms disclosed. On the contrary, the present disclosure is intended to cover all modifications, equivalents, and alternatives falling within the spirit and scope of the present disclosure. Like numbers refer to like elements throughout the description of the figures.

It should be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in the present disclosure, “one or more of A and B” may mean “one or more of A or B” or “one or more of combinations of one or more of A and B”.

In the present disclosure, “(re)transmission” may refer to “transmission”, “retransmission”, or “transmission and retransmission”. Further, “(re)configuration” may refer to “configuration”, “reconfiguration”, or “configuration and reconfiguration”. Additionally, “(re)connection” may refer to “connection”, “reconnection”, or “connection and reconnection”. Further, “(re)access” may mean “access”, “re-access”, or “access and re-access”.

It should be understood that when an element is referred to as being “connected” or “coupled” to another element, the element can be directly connected or coupled to the other element or one or more intervening elements may be present between the element and the other element. In contrast, when an element is referred to as being “directly connected” or “directly coupled” to another element, there are no intervening elements present between the element and the other element.

The terminology used herein is for the purpose of describing particular embodiments only and is not intended to be limiting of the present disclosure. As used herein, the singular forms are intended to include the plural forms as well, unless the context clearly indicates otherwise. It should be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure pertains. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

Hereinafter, embodiments of the present disclosure are be described in detail with reference to the accompanying drawings. In order to facilitate general understanding in describing the present disclosure, the same components in the drawings are denoted with the same reference signs and repeated description thereof has been omitted. In addition to the embodiments explicitly described in the present disclosure, operations may be performed according to a combination of the embodiments, extensions of the embodiments, and/or modifications of the embodiments. Some operations may be omitted. The order of performance of operations may be changed.

When a method (e.g., transmission or reception of a signal) performed at a first communication node among communication nodes is described, a corresponding second communication node may perform a method (e.g., reception or transmission of the signal) corresponding to the method performed at the first communication node. For example, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g., payload-based NTN), operations of a base station may refer to operations of a satellite and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), roadside unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In embodiments, signaling may be at least one of higher layer signaling, medium access control (MAC) signaling, or physical (PHY) signaling. Messages used for higher layer signaling may be referred to as ‘higher layer messages’ or ‘higher layer signaling messages.’ Messages used for MAC signaling may be referred to as ‘MAC messages’ or ‘MAC signaling messages.’ Messages used for PHY signaling may be referred to as ‘PHY messages’ or ‘PHY signaling messages.’ The higher layer signaling may refer to a transmission and reception operation of system information (e.g., master information block (MIB), system information block (SIB)) and/or RRC messages. The MAC signaling may refer to a transmission and reception operation of a MAC control element (CE). The PHY signaling may refer to a transmission and reception operation of control information (e.g., downlink control information (DCI), uplink control information (UCI), and/or sidelink control information (SCI)).

In embodiments, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”.

A communication system may include at least one of a terrestrial network, non-terrestrial network, 4G communication network (e.g., long-term evolution (LTE) communication network), 5G communication network (e.g., new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which embodiments may be applied is not limited to the content described below. The embodiments may be applied to various communication networks (e.g., 4G communication network, 5G communication network, and/or 6G communication network). A communication network may be used in the same sense as a communication system.

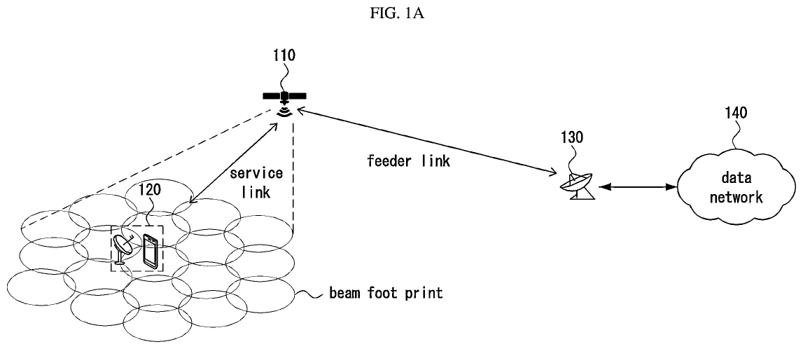

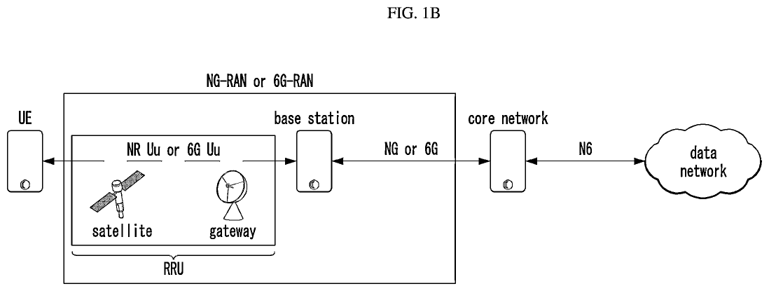

FIG. 1A is a conceptual diagram illustrating a first embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, and/or an unmanned aircraft system (UAS) platform. The UAS platform may include a high altitude platform station (HAPS). A non-GEO satellite may be an LEO satellite and/or MEO satellite.

The communication node 120 may include a communication node (e.g., a user equipment (UE) or a terminal) located on a terrestrial site and/or a communication node (e.g., an airplane, a drone) located on a non-terrestrial space. A service link may be established between the satellite 110 and the communication node 120. The service link may be a radio link, for example. The satellite 110 may provide communication services to the communication node 120 using one or more beams. The shape of a footprint of the beam of the satellite 110 may be elliptical or circular.

The communication node 120 may perform communications (e.g., downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g., base stations supporting 4G, 5G, and/or 6G functionality) as well as the satellite 110 and may perform DC operations based on the techniques defined in 4G, 5G, and/or 6G technical specifications.

The gateway 130 may be located on a terrestrial site. A feeder link may be established between the satellite 110 and the gateway 130. The feeder link may be a radio link, for example. The gateway 130 may be referred to as a ‘non-terrestrial network (NTN) gateway’. The communications between the satellite 110 and the gateway 130 may be performed based on an NR-Uu interface, a 6G-Uu interface, and/or a satellite radio interface (SRI). The gateway 130 may be connected to the data network 140. There may be a ‘core network’ between the gateway 130 and the data network 140. For example, the gateway 130 may be connected to the core network and the core network may be connected to the data network 140. The core network may support the 4G communication technology, 5G communication technology, and/or 6G communication technology. For example, the core network may include an access and mobility management function (AMF), a user plane function (UPF), a session management function (SMF), and/or the like. The communications between the gateway 130 and the core network may be performed based on an NG-C/U interface or 6G-C/U interface.

FIG. 1B is a conceptual diagram illustrating a second exemplary embodiment of a non-terrestrial network. According to the second embodiment of FIG. 1B, there may be a ‘core network’ between the gateway 130 and the data network 140 in a transparent payload-based NTN.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface. the communications between the base station and the core network (e.g., AMF, UPF, SMF, and/or the like) may be performed based on an NG-C/U interface or 6G-C/U interface.

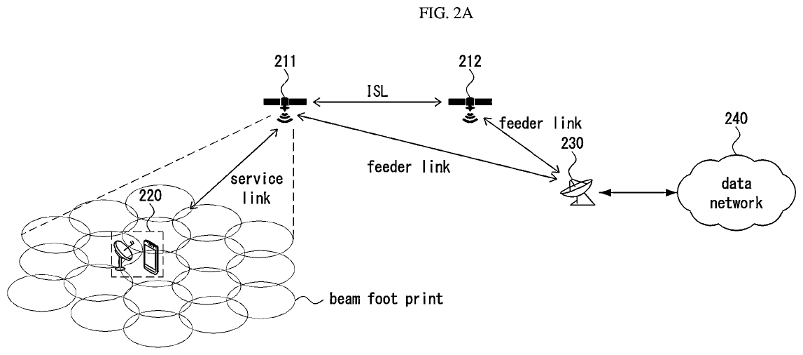

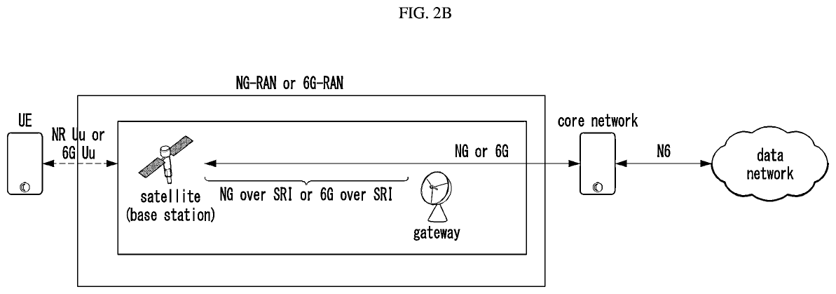

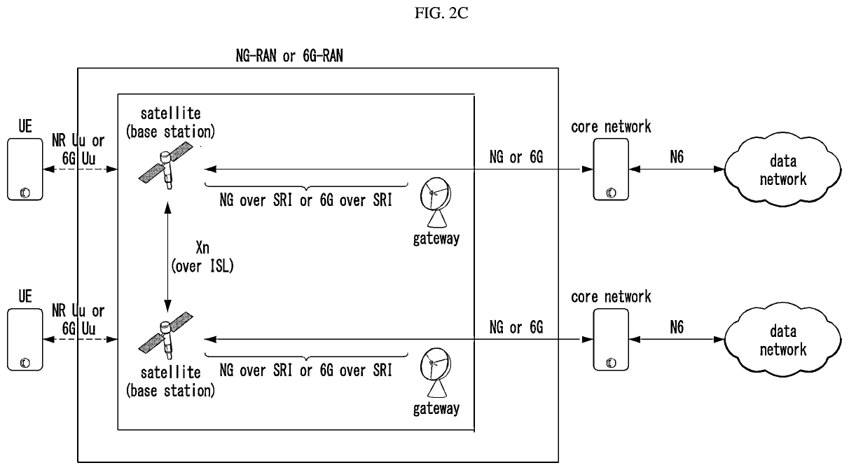

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g., demodulation, decoding, re-encoding, re-modulation, and/or filtering operation) on a payload received from other entities (e.g., the communication node 220 or the gateway 230), and may transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212. An inter-satellite link (ISL) may be established between the satellite 211 and the satellite 212. The ISL may operate in an RF frequency band or an optical band. The ISL may be established optionally. The communication node 220 may include a terrestrial communication node (e.g., UE or terminal) and/or a non-terrestrial communication node (e.g., airplane or drone). A service link (e.g., radio link) may be established between the satellite 211 and communication node 220. The satellite 211 may provide communication services to the communication node 220 using one or more beams.

The communication node 220 may perform communications (e.g., downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g., base stations supporting 4G, 5G, and/or 6G functionality) as well as the satellite 211. The communication node 220 may perform DC operations based on the techniques defined in 4G, 5G, and/or 6G technical specifications.

The gateway 230 may be located on a terrestrial site. A feeder link may be established between the satellite 211 and the gateway 230. Also, a feeder link may be established between the satellite 212 and the gateway 230. The feeder link may be a radio link, for example. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

FIG. 2B is a conceptual diagram illustrating a fourth exemplary embodiment of a non-terrestrial network. FIG. 2C is a conceptual diagram illustrating a fifth exemplary embodiment of a non-terrestrial network. As shown in FIG. 2B and FIG. 2C, there may be a ‘core network’ between the gateway 230 and the data network 240.

As shown in FIG. 2B and FIG. 2C, the gateway may be connected with the core network and the core network may be connected with the data network. The core network may support the 4G communication technology, 5G communication technology, and/or 6G communication technology. The core network may include AMF, UPF, SMF, and/or the like. Communication between the gateway and the core network may be performed based on an NG-C/U interface or 6G-C/U interface. Functions of a base station may be performed by the satellite. In other words, the base station may be located on the satellite. A payload may be processed by the base station located on the satellite. Base stations located on different satellites may be connected to the same core network. One satellite may have one or more base stations. In the non-terrestrial network of FIG. 2B, an ISL between satellites may not be established. In the non-terrestrial network of FIG. 2C, an ISL between satellites may be established.

The entities (e.g., satellite, base station, UE, communication node, gateway, and the like) constituting the non-terrestrial network shown in FIGS. 1A, 1B, 2A, 2B, and/or 2C, according to embodiments, may be configured as follows.

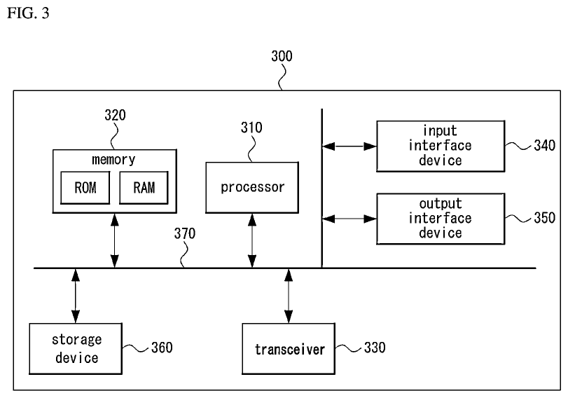

FIG. 3 is a block diagram illustrating an embodiment of an entity constituting a non-terrestrial network.

Referring to FIG. 3, an entity 300 may include at least one processor 310, a memory 320, and a transceiver 330 connected to a network to perform communication. In addition, the entity 300 may further include an input interface device 340, an output interface device 350, a storage device 360, and/or the like. The components included in the entity 300 may be connected by a bus 370 to communicate with each other.

However, each component included in the entity 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to embodiments of the present disclosure may be performed. Each of the memory 320 and the storage device 360 may be configured as at least one of a volatile storage medium and/or a nonvolatile storage medium. For example, the memory 320 may be configured with at least one of a read only memory (ROM) and/or a random access memory (RAM).

In embodiments, NTN reference scenarios may be defined as shown in Table 1 below.

TABLE 1

| | NTN shown in FIG. 1 | NTN shown in FIG. 2 |
|---|---|---|
| GEO | Scenario A | Scenario B |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g., a GEO satellite that supports a transparent function), this may be referred to as ‘scenario A’. When the satellites 211 and 212 in the NTN shown in FIG. 2A, FIG. 2B, and/or FIG. 2C are GEO satellites (e.g., GEOs that support a regenerative function), this may be referred to as ‘scenario B’.

When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’. Parameters for the scenarios defined in Table 1, according to embodiments, may be defined as shown in Table 2 below.

FIG. 2 shows parameters defined for the NTN reference scenarios defined in Table 1, according to embodiments.

TABLE 2

| | Scenarios A and B | | Scenarios C and D |
|---|---|---|---|
| Altitude | 35,786 | kilometers (km) | 600 km |
| | | | 1,200 km |
| Spectrum (service link) | <6 GHz (e.g., 2 GHz) | | |
| | >6 GHz (e.g., DL 20 GHz, UL 30 GHz) | | |
| Maximum channel | 30 MHz for band <6 GHz | | |
| bandwidth capability | 1 GHz for band >6 GHz | | |
| (service link) | | | |
| Maximum distance | 40,581 | km | 1,932 km (altitude of 600 |
| between satellite and | | | km) |
| communication node (e.g., | | | 3,131 km (altitude of |
| UE) at the minimum | | | 1,200 km) |
| elevation angle | | | |
| Maximum round trip | Scenario A: 541.46 | | Scenario C: (transparent |
| delay (RTD) | milliseconds (ms) | | payload: service and |
| (only propagation delay) | (service and feeder links) | | feeder links) |
| | Scenario B: 270.73 ms | | −5.77 ms (altitude of 60 |
| | (only service link) | | 0km) |
| | | | −41.77 ms (altitude of |
| | | | 1,200 km) |
| | | | Scenario D: (regenerative |
| | | | payload: only service link) |
| | | | −12.89 ms (altitude of 600 |
| | | | km) |
| | | | −20.89 ms (altitude of |
| | | | 1,200 km) |
| Maximum differential | 10.3 | ms | 3.12 ms (altitude of 600 |

| | |
|---|---|
| delay within a cell | km) |
| | 3.18 ms (altitude of 1,200 |
| | km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario | Scenario | Scenario | Scenario |
|---|---|---|---|---|
| | A | B | C1-2 | D1-2 |
| Satellite altitude | 35,786 km | | 600 km | |
| Maximum RTD in a | 541.75 ms | 270.57 ms | 28.41 ms | 12.88 ms |
| radio interface | (worst case) | | | |
| between base | | | | |
| station and UE | | | | |
| Minimum RTD in a | 477.14 ms | 238.57 ms | 8 ms | 4 ms |
| radio interface | | | | |
| between base | | | | |
| station and UE | | | | |

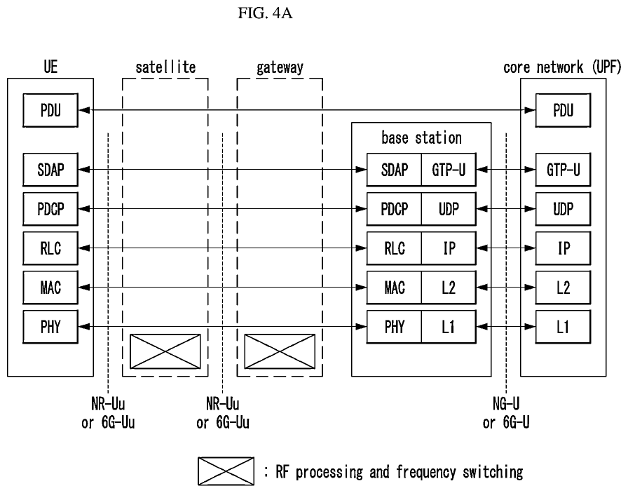

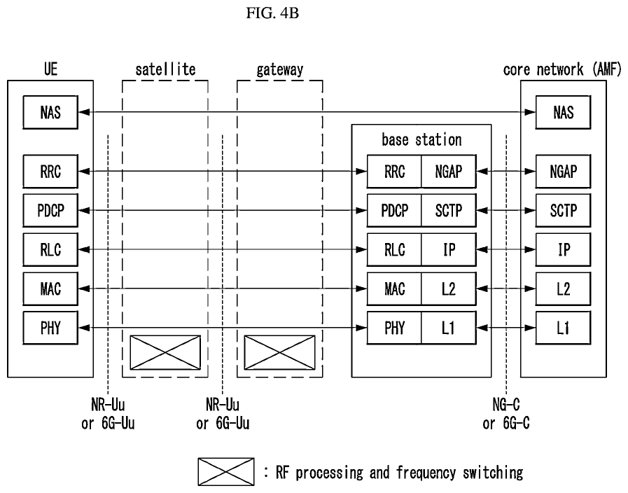

FIG. 4A is a conceptual diagram illustrating an embodiment of a protocol stack of a user plane in a transparent payload-based non-terrestrial network. FIG. 4B is a conceptual diagram illustrating an embodiment of a protocol stack of a control plane in a transparent payload-based non-terrestrial network.

As shown in FIGS. 4A and 4B, user data may be transmitted and received between a UE and a core network (e.g., UPF) and control data (e.g., control information) may be transmitted and received between the UE and the core network (e.g., AMF). Each of the user data the and control data may be transmitted and received through a satellite and/or gateway. The protocol stack of the user plane shown in FIG. 4A may be applied identically or similarly to a 6G communication network. The protocol stack of the control plane shown in FIG. 4B may be applied identically or similarly to a 6G communication network.

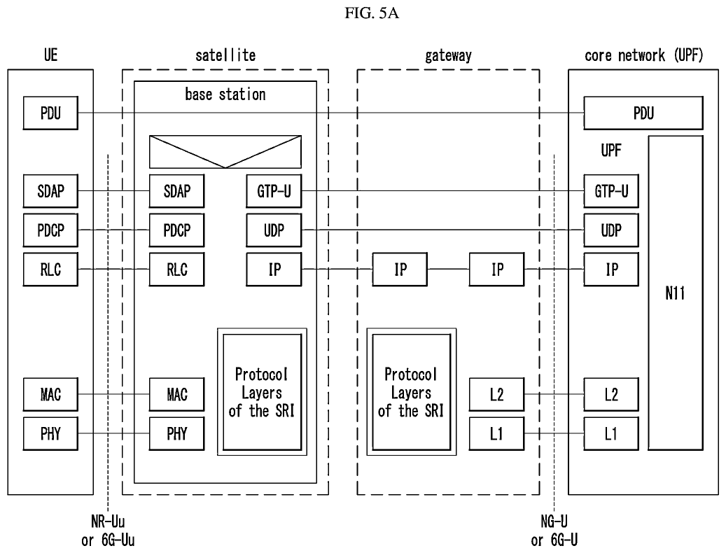

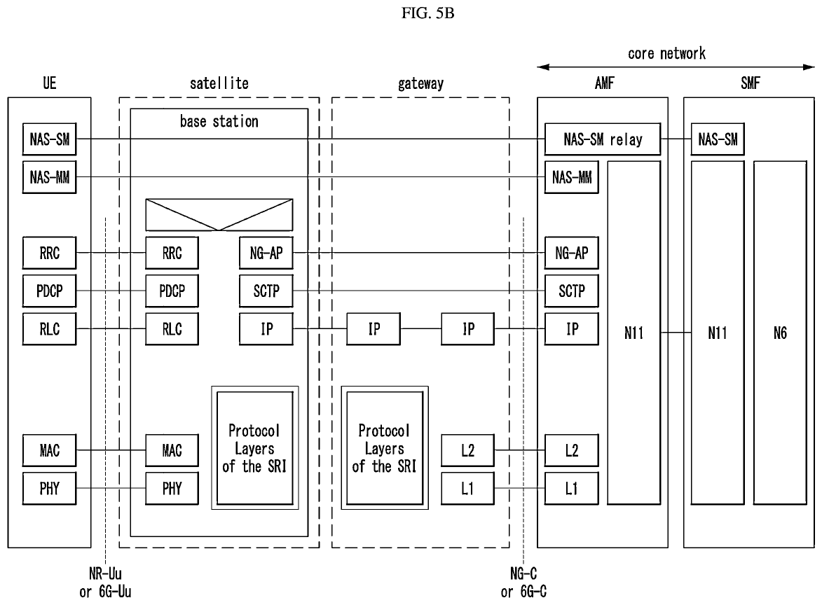

FIG. 5A is a conceptual diagram illustrating an embodiment of a protocol stack of a user plane in a regenerative payload-based non-terrestrial network. FIG. 5B is a conceptual diagram illustrating a first exemplary embodiment of a protocol stack of a control plane in a regenerative payload-based non-terrestrial network.

As shown in FIGS. 5A and 5B, each of user data and control data (e.g., control information) may be transmitted and received through an interface between a UE and a satellite (e.g., base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

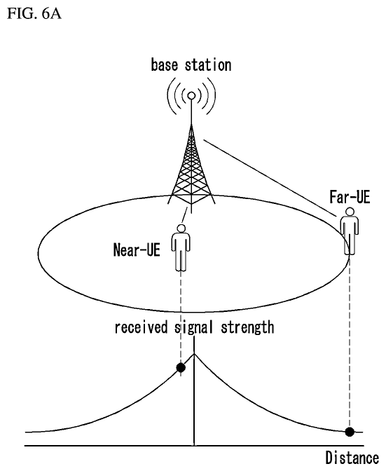

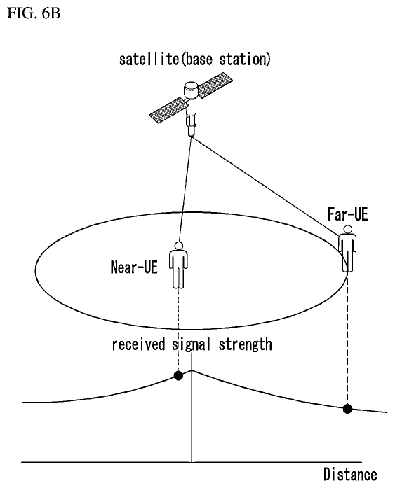

FIG. 6A is a conceptual diagram illustrating a measurement result of reference signal received powers (RSRPs) in a terrestrial network. FIG. 6B is a conceptual diagram illustrating a measurement result of RSRPs in a non-terrestrial network.

As shown in FIG. 6A, a path loss exponent may be assumed to be 4, and differences in RSRP according to distances (e.g., 100 meters (m), 500 m, 1 kilometer (km), and 10 km) from a base station in a terrestrial network may be as shown in Table 4 below. A reference position may be represented as a distance from the base station to the corresponding reference position.

TABLE 4

| Reference | Distance from a base station | | | |
|---|---|---|---|---|
| position | 100 m | 500 m | 1 km | 10 km |
| 100 ms | 0 dB | −28 dB | −40 dB | −80 dB |
| 500 ms | — | 0 dB | −12 dB | −52 dB |
| 1 km | — | — | 0 dB | −40 dB |
| 10 km | — | — | — | 0 dB |

As shown in FIG. 6B, in a non-terrestrial network, a path loss exponent may be assumed to be 2 and a satellite may be a LEO satellite with an altitude of 600 km. In the non-terrestrial network, a difference in RSRP according to a distance (e.g., 10 km, 50 km, 100 km, 500 km) between Nadir and a UE may be shown in Table 5 below. A distance between the satellite and the UE, depending on the distance between Nadir and the UE, may be 600 km, 602 km, 608 km, or 781 km.

TABLE 5

| | | | | |
|---|---|---|---|---|
| Distance between Nadir | 10 km | 50 km | 100 km | 500 km |
| and UE | | | | |
| Distance between the | 600 km | 602 km | 608 km | 781 km |
| satellite and the UE | | | | |
| Reference position | 0 dB | 0 dB | −0.1 dB | −2.3 dB |
| (10 km) | | | | |

In a satellite that supports multi-beam, if a cell radius is about 50 km, a difference in a path length may be small. A distance between the satellite and the UE at 500 km from Nadir is only 781 km, and a difference between an RSRP at 500 km from Nadir and an RSRP at 10 km from Nadir may be −2.3 dB.

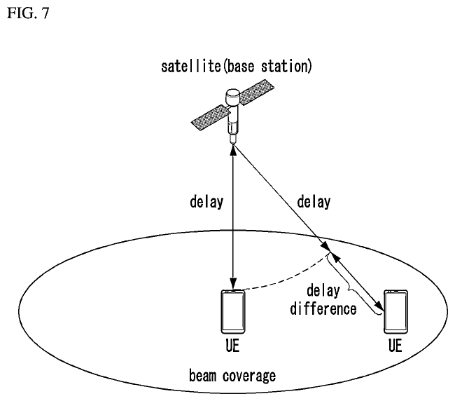

FIG. 7 illustrates an embodiment of a path according to a position of a UE within a beam coverage of a satellite.

As shown in FIG. 7, a difference (or delay difference) in a path between a satellite and a UE may occur depending on a position of the UE within the satellite's beam coverage (e.g., satellite coverage). The difference (or delay difference) in the path between the satellite (e.g., base station) and the UE according to the position of the UE in a non-terrestrial network may not be larger than a difference (or delay difference) in a path between a base station and a UE depending on a location of the UE in a terrestrial network.

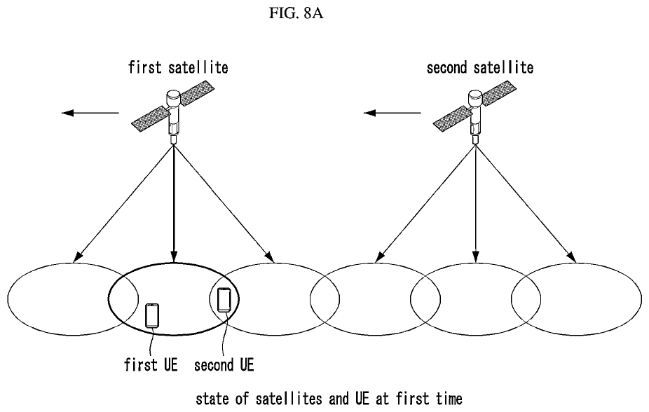

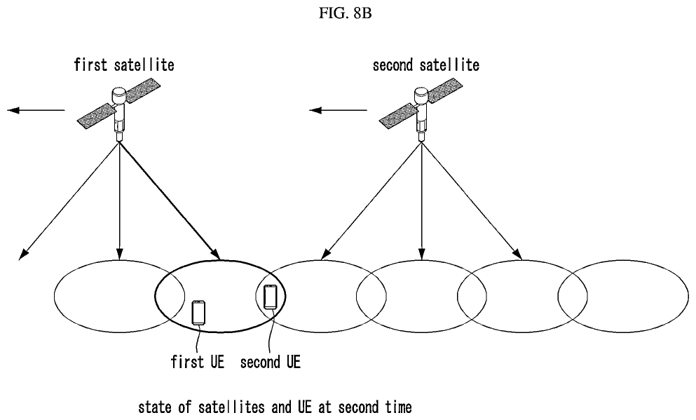

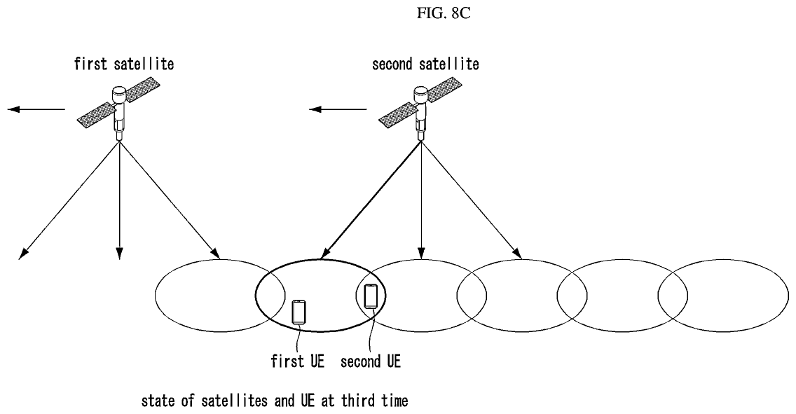

FIG. 8A is a conceptual diagram illustrating a state of a satellite and a UE at a first time in an earth fixed beam (EFB)-based NTN, according to an embodiment. FIG. 8B is a conceptual diagram illustrating a state of the satellite and the UE at a second time in the EFB-based NTN, according to an embodiment. FIG. 8C is a conceptual diagram illustrating a state of the satellite and the UE at a third time in the EFB-based NTN, according to an embodiment.

As shown in FIGS. 8A-8C, in an EFB-based NTN (hereinafter referred to as ‘EFB NTN’), each of a first satellite and a second satellite may move over time (e.g., first time→second time→third time). Each of the first satellite and the second satellite may support EFBs. The third time may be after the second time. The second time may be after the first time. A handover procedure may be classified into an intra-satellite (SAT) handover procedure and an inter-SAT handover procedure. Each of the intra-SAT handover procedure and inter-SAT handover procedure may be a general handover procedure or a conditional handover (CHO) procedure.

In the intra-SAT handover procedure, UE(s) may perform handover procedure(s) for cells of the same satellite. Accordingly, the intra-SAT handover procedure may be performed through beam switching in the same satellite. In the intra-SAT handover procedure, all UEs connected to a first cell of a first satellite may be handed over to a second cell of the first satellite. In this case, all UEs may be handed over to the second cell at the same or similar time. A handover procedure performed in a period from the first time to the second time may be the intra-SAT handover procedure. The EFBs may be supported through beam steering within the same satellite.

In the inter-SAT handover procedure, UE(s) may perform handover procedure(s) for different satellites. In the inter-SAT handover procedure, all UEs connected to a first satellite (e.g., a specific cell of the first satellite) may be handed over to a second satellite (e.g., a specific cell of the second satellite). In this case, all UEs may be handed over to the second satellite at the same or similar time. The handover procedure performed in a period from the second time to the third time may be the inter-SAT handover procedure. The EFBs may be supported through a new cell on a new satellite (e.g., the second satellite).

Due to a high altitude in NTN, RSRP-based handover procedures may not be efficient. Therefore, a handover procedure suitable for NTN is required. In the EFB NTN, a cell coverage on the ground may be maintained even when the satellite moves. In other words, the satellite may support a fixed cell coverage. The intra-SAT handover procedure and/or the inter-SAT handover procedure may be performed simultaneously for UEs (e.g., all UEs or some UEs) within the same cell. An efficient handover procedure that takes into account the characteristics of EFB NTN described above may be required.

In the EFB NTN, at least one of a cell service time which is a remaining service time or a cell service timer for the cell service time may be introduced. In the NTN, the handover procedure may be performed based on the cell service timer. Considering the characteristics of NTN (e.g., the characteristic that handover procedures for all UEs within the same cell are performed simultaneously), the handover procedure may be performed based on a satellite triggering scheme or a UE triggering scheme. If the satellite triggering scheme is used, the satellite may trigger the handover procedure based on the cell service timer. If the UE triggering scheme is used, the UE may trigger the handover procedure based on the cell service timer. In the NTN, constellation of satellites is known and the positions and motions of the satellites over time may be predicted with high accuracy, so the satellite triggering scheme may be applied.

### [Cell Service Timer]

The cell service timer may be referred to as cTimer. The cell service timer may be referred to as a cell expiration timer. The cell service timer may be a timer that defines a time (e.g., remaining time) during which communication services can be provided in a cell where the UE is located. The cell service timer may have the following characteristic(s).
The cell service timer may be an internal timer of the UE or satellite.
The cell service timer may be set to a cell-specific value.
Information on the cell service timer (e.g., value, initial value, setting value, and/or maximum value of the cell service timer) may be included in system information and/or RRC message. The satellite may periodically transmit the system information and/or RRC message including the information on the cell service timer (i.e., service cell timer information). The information on the cell service timer may be transmitted in a broadcast manner. The UE may receive the information on the cell service timer from the satellite. The information on the cell service timer may include parameter(s) used to determine a value of the cell service timer. When the information on the cell service timer is transmitted periodically, information indicating a transmission periodicity of the cell service timer information may be signaled from the satellite to the UE. The transmission periodicity of the cell service timer information may be variably set based on the cell service timer.
Alternatively, the information on the cell service timer may be signaled from the satellite to the UE at a time of performing an initial access procedure, a time of performing a connection establishment procedure, and/or a time of handover. The information on the cell service timer may include information indicating a value (e.g., initial value, setting value, maximum value) and/or a decrement interval of the cell service timer. The UE may independently determine the value of the cell service timer based on the information signaled from the satellite. For example, the UE may decrease the value of the cell service timer according to the decrement interval. When the above-described method is used, the information on the cell service timer may be signaled only once at the time of performing the initial access procedure, the time of performing the connection establishment procedure, and/or the time of handover.
In the EFB NTN, the value of the cell service timer may be the same as a value of a satellite (SAT) service timer. The SAT service timer may be referred to as sTimer. The SAT service timer may be referred to as a SAT expiration timer. The SAT service timer may be a timer that defines a time (e.g., remaining time) during which communication services can be provided in a coverage of the satellite where the UE is located.
The UE may know at least one of satellite ephemeris information, UE location information (e.g., UE location information acquired through a global navigation satellite system (GNSS)), elevation angle information, or a distance from the UE to Nadir.
When the cell service timer expires (e.g., when the value of the cell service timer becomes 0), the UE may determine that a time during which communication services can be provided in a specific cell has ended.

### [Variable Measurement Procedure]

Considering an ephemeris and a movement speed of a satellite in a LEO-based NTN, a UE may be likely to belong to the same cell for a long period of time. This may mean that a value (e.g., initial value) of the cell service timer is large. If the value of the cell service timer is large, a possibility that the UE selects a new cell in the NTN where the ephemeris and movement speed of the satellite are deterministic may be low. In this case, a need for measurement procedures may be low. On the other hand, when the value of the cell service timer decreases or when the value of the cell service timer is equal to or below a certain threshold, it may be required for the measurement procedure to be performed frequently.

If the value of the cell service timer exceeds a certain threshold, an intermittent measurement procedure (e.g., first measurement procedure) may be performed. If the value of the cell service timer is equal to or below a certain threshold, a frequent measurement procedure (e.g., second measurement procedure) may be performed. A measurement periodicity in the intermittent measurement procedure may be longer than that in the frequent measurement procedure. A measurement reporting periodicity (e.g., reporting periodicity of a measurement result) in the intermittent measurement procedure may be longer than a measurement reporting periodicity in the frequent measurement procedure. The RSRP threshold may be set independently for the intermittent and frequent measurement procedures.

The satellite may signal, to the UE, configuration information for the intermittent measurement procedure (e.g., measurement periodicity, measurement reporting periodicity, and/or RSRP threshold), configuration information for the frequent measurement procedure (e.g., measurement periodicity, measurement reporting periodicity, and/or RSRP threshold), and/or a specific threshold for the value of the cell service timer. The UE may receive, from the satellite, the configuration information for the intermittent measurement procedure, the configuration information for the frequent measurement procedure, and/or the specific threshold for the value of the cell service timer. If the value of the cell service timer exceeds the specific threshold, the UE may perform the intermittent measurement procedure based on the configuration information signaled from the satellite. If the value of the cell service timer is equal to or below the specific threshold, the UE may perform the frequent measurement procedure based on the configuration information signaled from the satellite. According to the above-described method, power consumption of the UE due to performing unnecessary measurement procedures can be reduced. Further, signaling overhead according to the measurement reporting procedures can be reduced.

In the EFB NTN, the connection between the UE and the same satellite and/or the connection between the UE and the same cell may be maintained for a time corresponding to cTimer (i.e., cell service timer). The measurement procedure may need to be performed taking into account the above-described satellite operation scheme. In the EFB NTN, the connection between the UE and the current satellite (e.g., serving satellite) may be maintained for the time corresponding to cTimer and the value of cTimer may be equal to the value of sTimer.

In the EFB NTN, cTimer is assigned (e.g., signaled) to the UE at a time of selecting a new satellite (e.g., when handed over to a new satellite) and/or a time of selecting a new cell (e.g., when handed over to a new cell). Alternatively, in the EFB NTN, cTimer may be periodically assigned (e.g., signaled) to the UE. A satellite that support multiple beams may configure a plurality of cells. In this case, a value (e.g., initial value, setting value) of cTimer may vary depending on the position of the cell. The value of cTimer may be determined (e.g., calculated) based on satellite constellation and/or terminal location.

If the value of cTimer is large (e.g., the value of cTimer exceeds a specific threshold) or if the handover procedure is completed, a probability that a handover procedure (e.g., a new handover procedure) is triggered may be low. Therefore, the UE may perform the intermittent measurement procedure. Alternatively, the UE may not perform the measurement procedure. If the value of cTimer is small (e.g., when the value of cTimer is equal to or below a specific threshold or if the value of cTimer becomes small, the UE may perform the frequent measurement procedure. According to the above-described method, the number of times the measurement procedure is performed may be reduced.

Alternatively, the measurement procedure (e.g., intermittent measurement procedure and/or frequent measurement procedure) may be performed independently of the value of cTimer. Since the UE moves to another cell depending on the position and/or mobility (e.g., speed and/or direction) of the UE, the measurement procedure may be performed taking into account the position and/or mobility of the UE. For example, if the UE's speed exceeds a speed threshold, the UE may perform the frequent measurement procedure. If the UE's speed is equal to or below a speed threshold, the UE may perform the intermittent measurement procedure.

The minimum value of the measurement periodicity may be 20 msec. The measurement periodicity may be set based on Equation 1 below. The measurement reporting periodicity (i.e., measurement result reporting periodicity) may be set to be the same as the measurement periodicity.

$$measurement periodicity = 20 msec \times {2}^{n} \qquad Equation 1$$

In an example, n in Equation 1 may be determined based on Equation 2 below.

$$n = ⌊ N \times f ( \frac{c T i m e r}{cTimer\_max} ) ⌋ \qquad Equation 2$$

In Equation 2, N, cTimer_max, and/or f (x) may be configured to the UE by the satellite. Alternatively, N, cTimer_max, and/or f (x) may be predefined in the technical specifications. Alternatively, N, cTimer_max, and/or f (x) may be determined by the UE. cTimer_max may be the maximum value of the cell service timer. cTimer may be the value (e.g., current value) of the cell service timer. N may be a natural number.

The UE may determine the measurement periodicity based on Equation 1 and Equation 2, identify a reception quality (e.g., RSRP, RSRQ, received signal strength indicator (RSSI)) of the satellite by performing a measurement operation based on the measurement periodicity. The UE may then report a measurement result (e.g., received signal quality) to the satellite. The measurement result reporting periodicity may be set to be the same as or different from the measurement periodicity. In addition, the satellite may estimate the measurement periodicity and/or measurement reporting periodicity of the UE based on Equation 1 and Equation 2. The satellite may receive the measurement result from the UE based on the measurement periodicity and/or measurement reporting periodicity.

Alternatively, n in Equation 1 may be set based on Table 6 below. The satellite may signal information of Table 6 to the UE. The UE may receive the information of Table 6 from the satellite. Alternatively, Table 6 may be predefined in the technical specifications. In Table 6, cTimer may be the value (e.g., current value) of the cell service timer.

TABLE 6

| cTimer | 20 min | 10 min | . . . | 20 msec |
|---|---|---|---|---|
| n | X1 | X2 | | 0 |

The UE may determine the measurement periodicity based on Equation 1 and Table 6, may identify the received signal quality (e.g., RSRP, RSRQ, RSSI) of the satellite by performing a measurement operation based on the measurement periodicity. The UE may then report a measurement result (e.g., received signal quality) to the satellite. The measurement result reporting periodicity may be set to be the same as or different from the measurement periodicity. In addition, the satellite may estimate the measurement periodicity and/or measurement reporting periodicity of the UE based on Equation 1 and Table 6. The satellite may receive the measurement result from the UE based on the measurement periodicity and/or measurement reporting periodicity.

A time of performing the measurement reporting procedure may be configured by an offset (hereinafter referred to as ‘reporting offset’) with respect to a time of performing the measurement procedure. The satellite may set a reporting offset and signal information on the reporting offset to the UE. The UE may receive the information on the reporting offset from the satellite. The UE may perform a measurement procedure and perform a measurement reporting procedure after the reporting offset from a time of performing the measurement procedure. The satellite may receive a measurement result from the UE considering the reporting offset. Alternatively, the reporting offset may be predefined in the technical specifications. Alternatively, the reporting offset may be set by the UE.

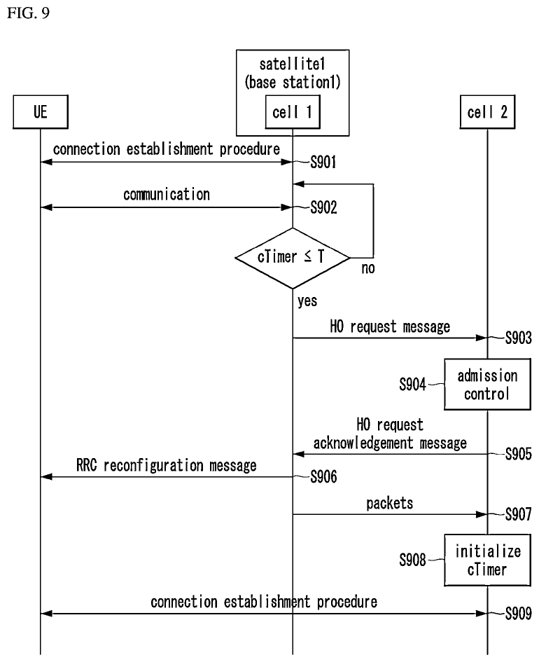

FIG. 9 is a sequence chart illustrating an embodiment of a handover procedure based on the satellite triggering scheme in NTN.

As shown in FIG. 9, the NTN (e.g., EFB NTN) may include satellite(s) and UE(s). A satellite 1 may form one or more cells (e.g., cell 1) and may perform functions of a base station. A cell 2 may be a cell formed by the satellite 1 or a satellite 2. If the cell 2 is formed by the satellite 1, a handover procedure from the cell 1 to the cell 2 may be an intra-SAT handover procedure. If the cell 2 is formed by the satellite 2, a handover procedure from the cell 1 to the cell 2 may be an inter-SAT handover procedure. The operation of the cell may be an operation of the base station and/or an operation of the satellite. The embodiment of FIG. 9 may be applied to a conditional handover procedure as well as a general handover procedure.

In the EFB NTN, cTimer may be initialized when the UE is handed over to a new satellite or new cell. A satellite supporting a plurality of beams may form a plurality of cells. The plurality of cells may overlap (e.g., partially overlap). The value of cTimer (e.g., initial value, setting value) may vary depending on the position of the cell. The value of cTimer may be determined (e.g., calculated) based on satellite constellation and/or terminal location. The value of cTimer may decrease according to a decrement interval. As the value of cTimer decreases, a time to perform the handover procedure may get closer. If the value of cTimer is equal to or below a threshold T, the satellite 1 may trigger the handover procedure.

In the embodiment of FIG. 9, the UE may be connected to the satellite 1. In an operation S901, a connection establishment procedure between the UE and the satellite 1 may be performed. The connection establishment procedure may be an initial access procedure and may include a synchronization acquisition procedure between the UE and the satellite 1. In the connection establishment procedure between the UE and the satellite 1, the satellite 1 may signal handover configuration information and/or measurement configuration information to the UE. The UE may receive the handover configuration information and/or measurement configuration information from the satellite 1. The handover configuration information may include one or more information elements defined in Table 7 below. The UE may identify a handover scheme, cTimer, cTimer decrement interval, and/or cTimer threshold based on the one or more information elements defined in Table 7 below. Alternatively, the handover scheme, cTimer, cTimer decrement interval, and/or cTimer threshold may be predefined in the technical specifications. In this case, the UE may know the handover scheme, cTimer, cTimer decrement interval, and/or cTimer threshold without signaling from the satellite 1.

TABLE 7
Information elements
Handover scheme (e.g., satellite triggering scheme or UE
triggering scheme)
cTimer (e.g., initial value, setting value, and/or maximum value
of cTimer)
Parameter(s) used for determining cTimer
Decrement interval of cTimer
Parameter(s) used for determining a decrement interval of cTimer
cTimer threshold T

In the embodiment of FIG. 9, the handover scheme may be the satellite triggering scheme. In this case, the handover configuration information may only include the information element indicating the satellite triggering scheme and may not include the remaining information elements (i.e., cTimer-related information elements). Accordingly, if the satellite triggering scheme is used, cTimer may not be used in the UE.

The measurement configuration information may include one or more information elements defined in Table 8 below. The UE may identify the measurement periodicity and/or measurement reporting periodicity based on one or more information elements defined in Table 8 below. Alternatively, the measurement periodicity and/or measurement reporting periodicity may be predefined in the technical specifications. In this case, the UE may know the measurement periodicity and/or measurement reporting periodicity without signaling from the satellite 1.

TABLE 8
Information elements
Measurement periodicity
Parameter(s) used for determining measurement periodicity (e.g., n,
N, and/or cTimer_max in Equations 1 and 2)
Measurement reporting periodicity
Parameter(s) used for determining measurement reporting periodicity
RSRP threshold

Alternatively, the measurement configuration information may include intermittent measurement configuration information and frequent measurement configuration information. In this case, the measurement configuration information may include one or more information elements defined in Table 9 below. The intermittent measurement configuration information may be used for the intermittent measurement procedure. The frequent measurement configuration information may be used for the frequent measurement procedure. The UE may identify the measurement periodicity and/or measurement reporting periodicity based on one or more information elements defined in Table 9 below. Alternatively, the measurement periodicity and/or measurement reporting periodicity may be predefined in the technical specifications. In this case, the UE may know the measurement periodicity and/or measurement reporting periodicity without signaling from the satellite 1.

TABLE 9

| | Information element |
|---|---|
| intermittent | Measurement periodicity |
| measurement | Parameter(s) used for determining measurement periodicity |
| configuration | (e.g., n, N, and/or cTimer_max in Equations 1 and 2) |
| information | Measurement reporting periodicity |
| | Parameter(s) used for determining measurement reporting |
| | periodicity |
| | RSRP threshold |
| | Measurement periodicity |
| frequent | Parameter(s) used for determining measurement periodicity |
| measurement | (e.g., n, N, and/or cTimer_max in Equations 1 and 2) |
| configuration | Measurement reporting periodicity |
| information | Parameter(s) used for determining measurement reporting |
| | periodicity |
| | RSRP threshold |
| Threshold | A value that is a criterion for performing the intermittent |
| | measurement procedure or the frequent measurement procedure |

When the connection establishment procedure between the UE and the satellite 1 (e.g., cell 1) is completed, communication (e.g., downlink communication and/or uplink communication) between the UE and the satellite 1 may be performed in an operation S902. The UE(s) may measure reception quality(ies) (e.g., RSRP, RSRQ, RSSI) based on reference signals received from cell(s). The UE(s) may transmit a measurement result (e.g., reception quality(ies)) to the satellite 1 (e.g., cell 1). The satellite 1 (e.g., cell 1) may obtain information on the reception quality(ies) for the cell(s) from the UE(s).

The satellite 1 may have a value of cTimer for each cell. The satellite 1 may decrease the value of cTimer according to the decrement interval. For example, the satellite 1 may decrease the value of cTimer for the cell 1 according to the decrement interval. The satellite 1 may then compare the value of cTimer (e.g., current value) and a threshold (e.g., cTimer threshold T). If the value of cTimer for the cell 1 exceeds the threshold, the satellite 1 may not trigger a handover procedure. If the value of cTimer for the cell 1 is equal to or below the threshold, the satellite 1 may trigger a handover procedure (e.g., handover procedure for the UE(s) belonging to the cell 1).

In addition, if the value of cTimer for the cell 1 is equal to or below the threshold, the satellite 1 may transmit information indicating to perform the frequent measurement procedure (e.g., information indicating that the value of cTimer is equal to or below the threshold) to the UE. When the information indicating to perform the frequent measurement procedure is received from the satellite 1 (e.g., cell 1), the UE may perform the frequent measurement procedure instead of the intermittent measurement procedure. Until the information indicating to perform the frequent measurement procedure is received from the satellite 1 (e.g., cell 1), the UE may perform the intermittent measurement procedure.

If it is determined that a handover procedure is to be triggered, the satellite 1 (e.g., cell 1) may determine a target cell to which the UE(s) is to be handed over. For example, the satellite 1 (e.g., cell 1) may determine the target cell based on reception quality information received from the UE(s). Alternatively, the satellite 1 (e.g., cell 1) may determine the target cell based on other information (e.g., mobility information of the UE(s), information on cell(s) adjacent to the cell 1) instead of the reception quality information for the cell(s). When the target cell is determined to be the cell 2, the satellite 1 (e.g., cell 1) may, in an operation S903, transmit a handover (HO) request message to the cell 2, which is the target cell. The cell 2 may be a cell configured by the satellite 1 or a cell configured by a satellite 2. The cell 2 may receive the handover (HO) request message from the cell 1 and may determine whether to approve a handover procedure based on the HO request message, in an operation S904.

If the handover procedure is approved, the cell 2 may transmit a HO request acknowledgment message to the cell 1 in an operation S905. When the HO request acknowledgment message is received from the cell 2, the cell 1 may determine that the handover procedure has been approved in the cell 2. In this case, the cell 1 may transmit an RRC reconfiguration message (e.g., HO command message) to the UE(s)in an operation S906. In the operation S906, the RRC reconfiguration message may be transmitted to UE(s) belonging to the cell 1. When the handover procedure is performed on a UE basis, the RRC reconfiguration message may be transmitted to a specific UE belonging to the cell 1. When the handover procedure is performed on a cell basis, the RRC reconfiguration message may be transmitted to all UEs belonging to the cell 1. The cell 1 may transmit packets (e.g., PDUs) stored in a buffer, in-transit packets, and/or sequence number(s) (SN(s)) thereof to the cell 2 in an operation S907. The cell 2 may receive the packets (e.g., PDUs) stored in the buffer, in-transit packets, and/or SN(s) thereof from the cell 1. When a handover procedure for the UE(s) is performed, the cell 2 may reset cTimer (S908). For example, the value of cTimer in the cell 2 may be set to an initial value.

When the HO command message is received from the cell 1, the UE(s) may determine that the handover procedure is approved in the cell 2. Accordingly, the UE(s) may release the connection(s) with the cell 1 and perform a connection establishment procedure with the cell 2 in an operation S909. In the connection establishment procedure, the cell 2 may signal, to the UE(s), handover configuration information (e.g., information elements defined in Table 7) and/or measurement configuration information (e.g., information defined in Table 8 or Table 9) for the cell 2. The UE(s) may receive the handover configuration information and/or the measurement configuration information from the cell 2. The UE(s) may operate based on the received configuration information.

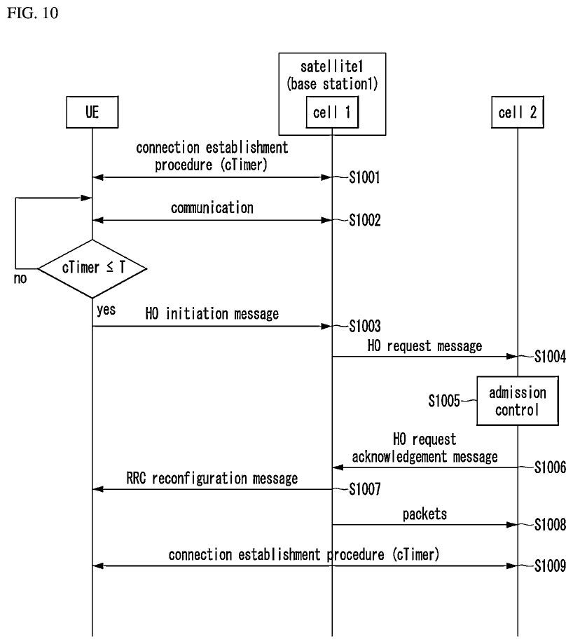

FIG. 10 is a sequence chart illustrating an embodiment of a handover procedure based on the UE triggering scheme in NTN.

As shown in FIG. 10, an NTN (e.g., EFB NTN) may include satellite(s) and UE(s). A satellite 1 may form one or more cells (e.g., cell 1) and may perform functions of a base station. A cell 2 may be a cell formed by the satellite 1 or satellite 2. If the cell 2 is formed by the satellite 1, a handover procedure from the cell 1 to the cell 2 may be an intra-SAT handover procedure. If the cell 2 is formed by the satellite 2, a handover procedure from the cell 1 to the cell 2 may be an inter-SAT handover procedure. Operations of the cell may be operations of the base station and/or operations of the satellite. The exemplary embodiment of FIG. 10 may be applied to a conditional handover procedure as well as a general handover procedure.

In the EFB NTN, cTimer may be initialized when a UE is handed over to a new satellite or new cell. A satellite supporting a plurality of beams may form a plurality of cells. The plurality of cells may overlap (e.g., partially overlap). The value of cTimer (e.g., initial value, setting value) may vary depending on the position of the cell. The value of cTimer may be determined (e.g., calculated) based on satellite constellation and/or terminal location. The value of cTimer may decrease according to a decrement interval. As the value of cTimer decreases, a time to perform the handover procedure may get closer. If the value of cTimer is equal to or below a threshold T, the UE may trigger the handover procedure.

Even though the satellite moves in the EFB NTN, the cell coverage in which communication services are provided by the satellite may be maintained. When the handover procedure is performed, UE(s) (e.g., all UEs or some UEs) belonging to the cell may be connected to a new satellite or new cell at the same time. In this case, it is not necessary for all UEs within the cell to perform a configuration operation and/or management operation for cTimer. That is, only specific UE(s) or assigned UE(s) may operate (e.g., configure and/or manage) cTimer. When cTimer is operated in a plurality of UEs, the accuracy of triggering of the handover procedure may be improved. If a HO initiation message triggering the handover procedure is first received, subsequent HO initiation messages may be ignored.

Alternatively, in the EFB NTN, a time of performing the handover procedure may vary for each UE within the cell due to an operation scheme and/or satellite state (e.g., satellite orbit). For example, the time of performing the handover procedure may vary depending on the position of the UE within the cell. In this case, it may be necessary to operate cTimer for each UE.

In the exemplary embodiment of FIG. 10, the UE may be connected to the satellite 1. That is, a connection establishment procedure may be performed between the UE and the satellite 1 in an operation S1001. The connection establishment procedure may mean an initial access procedure and may include a synchronization acquisition procedure between the UE and the satellite 1. In the connection establishment procedure between the UE and the satellite 1, the satellite 1 may transmit handover configuration information and/or measurement configuration information to the UE. The UE may receive the handover configuration information and/or the measurement configuration information from the satellite 1. The handover configuration information may include one or more information elements defined in Table 7 above. The UE may identify a handover scheme, cTimer, decrement interval of cTimer, and/or cTimer threshold based on the one or more information elements defined in Table 7 above.

Alternatively, the handover scheme, cTimer, decrement interval of cTimer, and/or cTimer threshold may be predefined in the technical specifications. In this case, the UE may know the handover scheme, cTimer, decrement interval of cTimer, and/or cTimer threshold without signaling from the satellite 1. In the embodiment of FIG. 10, the handover scheme may be the UE triggering scheme. In this case, cTimer may operate in UE(s). For example, all UEs, some UEs, or one UE belonging to the cell 1 may start cTimer. The value of cTimer may decrease according to the decrement interval.

The measurement configuration information may include one or more information elements defined in Table 8 above. The UE may identify a measurement periodicity and/or measurement reporting periodicity based on one or more information elements defined in Table 8 above. Alternatively, the measurement configuration information may include intermittent measurement configuration information and frequent measurement configuration information. In this case, the measurement configuration information may include one or more information elements defined in Table 9 above. The intermittent measurement configuration information may be used for the intermittent measurement procedure. The frequent measurement configuration information may be used for the frequent measurement procedure. The UE may identify the measurement periodicity and/or measurement reporting periodicity based on one or more information elements defined in Table 9 above. Alternatively, the measurement periodicity and/or measurement reporting periodicity may be predefined in the technical specifications. In this case, the UE may know the measurement periodicity and/or measurement reporting periodicity without signaling from the satellite 1.

When the connection establishment procedure between the UE and the satellite 1 (e.g., cell 1) is completed, communication (e.g., downlink communication and/or uplink communication) between the UE and the satellite 1 may be performed in an operation S1002. The UE(s) may measure reception quality(ies) (e.g., RSRP, RSRQ, RSSI) based on reference signals received from cell(s). The UE(s) may transmit a measurement result (e.g., reception quality(ies)) to the satellite 1 (e.g., cell 1). The satellite 1 (e.g., cell 1) may obtain information on the reception quality(ies) for the cell(s) from the UE(s). If the value (e.g., current value) of cTimer exceeds a threshold (e.g., T), the UE may report the measurement result to the satellite 1 by performing the intermittent measurement procedure. If the value (e.g., current value) of cTimer is below the threshold (e.g., T), the UE may report the measurement result to the satellite 1 by performing the frequent measurement procedure.

The UE may decrease the value of cTimer according to the decrement interval. The UE may then compare the value of cTimer with the threshold T. If the value of cTimer exceeds the threshold T, the UE may continue to perform communication with the cell 1. If the value of cTimer is below the threshold T, the UE may trigger a handover procedure. In this case, the UE may transmit a HO initiation message to the cell 1 in an operation S1003. The cell 1 may receive the HO initiation message from the UE. When the handover procedure is performed on a cell basis, the cell 1 may transmit a HO request message to a target cell (e.g., cell 2) when the first HO initiation message is received in an operation S1004. Here, the HO request message may include information indicating a request for a cell-level handover procedure. When the handover procedure is performed on a UE basis, the cell 1 may transmit a HO request message to the target cell (e.g., cell 2) when a HO initiation message is received from each UE in an operation S1004. Here, the HO request message may include information indicating a request for a UE-level handover procedure.

When the handover procedure is triggered, the satellite 1 (e.g., cell 1) may determine the target cell to which the UE(s) is to be handed over. For example, the satellite 1 (e.g., cell 1) may determine the target cell based on information of reception quality(ies) received from UE(s). Alternatively, the satellite 1 (e.g., cell 1) may determine the target cell based on other information (e.g., mobility information of the UE(s), information on cell(s) adjacent to the cell 1 instead of the information on reception quality(ies) for the cell(s). If the target cell is determined to be the cell 2, the HO request message may be transmitted to the cell 2 in the operation S1004 described above.

The cell 2 may be a cell configured by the satellite 1 or a cell configured by the satellite 2. The cell 2 may receive the HO request message from the cell 1 and determine whether to approve the handover procedure based on the HO request message in an operation S1005. If the handover procedure is approved, the cell 2 may transmit a HO request approval message to the cell 1 in an operation S1006. When the HO request approval message is received from the cell 2, the cell 1 may determine that the handover procedure has been approved in the cell 2. In this case, the cell 1 may transmit an RRC reconfiguration message (e.g., HO command message) to the UE(s) in an operation S1007. When the handover procedure is performed on a cell basis, the RRC reconfiguration message may be transmitted to all UEs belonging to the cell 1 in the operation S1007. Accordingly, the RRC reconfiguration message may be transmitted in a broadcast manner. When the handover procedure is performed on a UE basis, the RRC reconfiguration message may be transmitted to the corresponding UE belonging to the cell 1 in the operation S1007. That is, the RRC reconfiguration message may be a UE-specific message.

The cell 1 may transmit packets (e.g., PDUs) stored in a buffer, in-transit packets, and/or SN(s) thereof to the cell 2 in an operation S1008. The cell 2 may receive the packets (e.g., PDUs) stored in the buffer, in-transit packets, and/or SN(s) thereof from the cell 1. Accordingly, the UE(s) may release the connection(s) with the cell 1 and perform a connection establishment procedure with the cell 2 in an operation S1009. In the connection establishment procedure, the cell 2 may generate handover configuration information (e.g., information elements defined in Table 7) and/or measurement configuration information (e.g., information defined in Table 8 or Table 9) for the cell 2, and signal, to the UE(s), the handover configuration information and/or the measurement configuration information. The UE(s) may receive the handover configuration information and/or the measurement configuration information from the cell 2. The UE(s) may operate based on the received configuration information.

The operations of the method according to the embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus that is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of an apparatus, the aspects may indicate the corresponding descriptions according to a method. Further, the blocks or apparatus may correspond to the steps or operations of the method or the features of the steps or operations of the method. Similarly, the aspects described in the context of a method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some embodiments, a programmable logic device such as a field-programmable gate array may be used to perform some or all of functions of the methods described herein. In some embodiments, the field-programmable gate array may be operated with a microprocessor to perform one of the methods described herein. In embodiments, the methods are performed by a hardware device.

The description of the disclosure is merely illustrative in nature. Thus, variations that do not depart from the substance of the disclosure are intended to be within the scope of the disclosure. Such variations should not be regarded as a departure from the spirit and scope of the disclosure. Thus, it should be understood by those of ordinary skill in the art that various changes in form and details may be made without departing from the spirit and scope as defined by the following claims.

What is claimed is:

1. A method performed by a first cell of a first satellite, the method comprising:
performing a connection establishment procedure with a user equipment (UE);
after performing the connection establishment procedure, decreasing a value of a cell service timer, that indicates a time during which a communication service can be provided in the first cell, according to a decrement interval; and
in response to determining that the cell service timer is below a threshold, triggering a handover procedure.

2. The method according to claim 1, wherein performing the connection establishment procedure comprises:
transmitting first information indicating a handover scheme to the UE, wherein the first information indicates a satellite triggering scheme among the satellite triggering scheme or a UE triggering scheme, and wherein:
when the satellite triggering scheme is used, the handover procedure is triggered by a satellite, and
when the UE triggering scheme is used, the handover procedure is triggered by the UE.

3. The method according to claim 1, further comprising, in response to determining that the cell service timer is below the threshold, transmitting second information, that indicates performing a frequent measurement procedure instead of an intermittent measurement procedure, to the UE when configuration information of the intermittent measurement procedure and configuration information of the frequent measurement procedure are signaled to the UE in the connection establishment procedure.

4. The method according to claim 1, wherein triggering the handover procedure comprises:
determining a target cell for the UE as a second cell; and
transmitting a handover request message to the second cell.

5. The method according to claim 4, wherein the target cell is determined based on reception quality information received from the UE.

6. The method according to claim 4, wherein:
the first cell is configured by the first satellite based on earth fixed beam (EFB); and
the second cell is configured by the first satellite or a second satellite.

7. The method according to claim 1, wherein the handover procedure triggered by the first cell is performed on a UE basis or a cell basis.

8. A method of a user equipment (UE), the method comprising:
receiving first handover configuration information from a first cell, the first handover configuration information including information on a first cell service timer that indicates a time during which a communication service can be provided in the first cell of a first satellite;
decreasing a value of the first cell service timer according to a decrement interval; and
in response to determining that the first cell service timer is below a threshold, transmitting a handover initiation message to the first cell.

9. The method according to claim 8, wherein the first handover configuration information further includes at least one of information indicating the decrement interval, information indicating the threshold, or information indicating a handover scheme.

10. The method according to claim 9, wherein:
the handover scheme is classified into a satellite triggering scheme and a UE triggering scheme;
the first handover configuration information indicates the UE triggering scheme;
a handover procedure is triggered by the UE when the UE triggering scheme is used; and
the handover procedure is triggered by the first satellite when the satellite triggering scheme is used.

11. The method according to claim 8, further comprising receiving, from the first cell, intermittent measurement configuration information and frequent measurement configuration information, wherein:
an intermittent measurement procedure is performed based on the intermittent measurement configuration information when the first cell service timer exceeds the threshold; and
a frequent measurement procedure is performed based on the frequent measurement configuration information when the first cell service timer is equal to or below the threshold.

12. The method according to claim 11, wherein:
a measurement periodicity for the intermittent measurement procedure is set longer than a measurement periodicity for the frequent measurement procedure; and
a measurement reporting periodicity for the intermittent measurement procedure is set longer than a measurement reporting periodicity for the frequent measurement procedure.

13. The method according to claim 8, further comprising:
receiving a handover command message from the first cell; and
performing a connection establishment procedure with a second cell based on the handover command message,
wherein second handover configuration information, including information on a second cell service timer, that indicates a time during which communication services can be provided by the second cell, is received from the second cell in the connection establishment procedure.

14. The method according to claim 8, wherein:
a handover procedure triggered by the handover initiation message is performed on a UE basis or a cell basis;
the first cell is configured by the first satellite based on earth fixed beam (EFB); and
a second cell is configured by the first satellite or a second satellite.

15. A user equipment (UE) apparatus, comprising:
a processor; and
a memory storing one or more instructions executable by the processor,
wherein the one or more instructions, when executed by the processor, cause the processor to
receive first handover configuration information from a first cell, the first handover configuration information including information on a first cell service timer that indicates a time during which a communication service can be provided in the first cell of a first satellite,
decrease a value of the first cell service timer according to a decrement interval, and
in response to determining that the first cell service timer is below a threshold, cause a handover initiation message to be transmitted to the first cell.

16. The UE apparatus according to claim 15, wherein the first handover configuration information further includes at least one of information indicating the decrement interval, information indicating the threshold, or information indicating a handover scheme.

17. The UE apparatus according to claim 16, wherein:
the handover scheme is classified into a satellite triggering scheme and a UE triggering scheme;
the first handover configuration information indicates the UE triggering scheme;
a handover procedure is triggered by the UE when the UE triggering scheme is used; and
the handover procedure is triggered by the first satellite when the satellite triggering scheme is used.

18. The UE apparatus according to claim 15, wherein the one or more instructions, when executed by the processor further cause the processor receive, from the first cell, intermittent measurement configuration information and frequent measurement configuration information, and wherein:
an intermittent measurement procedure is performed based on the intermittent measurement configuration information when the first cell service timer exceeds the threshold; and
a frequent measurement procedure is performed based on the frequent measurement configuration information when the first cell service timer is equal to or below the threshold.

19. The UE apparatus according to claim 15, wherein the one or more instructions, when executed by the processor, further cause the processor to:
receive a handover command message from the first cell; and
perform a connection establishment procedure with a second cell based on the handover command message,
wherein second handover configuration information, including information on a second cell service timer, that indicates a time during which communication services can be provided by the second cell, is received from the second cell in the connection establishment procedure.

20. The UE apparatus according to claim 15, wherein:
a handover procedure triggered by the handover initiation message is performed on a UE basis or a cell basis;
the first cell is configured by the first satellite based on earth fixed beam (EFB); and
a second cell is configured by the first satellite or a second satellite.
